(19) United States
(12) Patent Application Publication
(10) Pub. No.: US 2013/0269800 A1
(43) Pub. Date: Oct. 17, 2013

(54) METHOD FOR MONITORING A FLUID INJECTION SYSTEM AND SYSTEM THEREOF

(71) Applicant: TI AUTOMOTIVE FUEL SYSTEMS SAS, Chalons-en-Champagne (FR)

(72) Inventor: Jean-Sebastien Fromont, Sarry (FR)

(21) Appl. No.: 13/860,800

(22) Filed: Apr. 11, 2013

(30) Foreign Application Priority Data
Apr. 11, 2012 (EP) EP12305422.3

(51) Int. Cl. G01M 13/00

(52) U.S. Cl. CPC G01M 13/00
USPC 137/565.16; 73/861; 73/40

(57) ABSTRACT

In at least some implementations, a method for monitoring a fluid injection system that has a fluid pump activated by a coil and a controller adapted to drive the coil with a driving voltage includes monitoring the evolution of current flowing through the coil and the evolution of the time derivative of said current, and monitoring two successive zero crossings of the time derivative of the current flowing through the coil. The method provides an easy and cost-efficient way to discriminate various operating states of a fluid injection system including a coil/solenoid driven pump.

### REFERENCE TO RELATED APPLICATIONS

This application claims the benefit of EP Application Serial No. 12305422.3 filed Apr. 11, 2012.

### TECHNICAL FIELD

The disclosure relates to fluid injection systems, and methods for monitoring such systems.

### BACKGROUND

Fluid injection systems may include a fluid tank, for instance an additive tank for a fuel additive injection system, a dosing pump, in the form of a piston pump activated by a coil, a fluid feeding hose, in fluid communication with the fluid tank, an injection check valve, terminating said hose, for delivering said fluid (for instance for inserting said additive into a fuel tank), and an electronic controller, feeding the coil with a control voltage, in order to activate the pump and deliver said fluid. The dosing pumps of such fluid injection systems can encounter diverse operative modes, such as normal operation with fluid, or abnormal operations. Abnormal operations may include pumping air instead of liquid, which can happen on system priming, or operation with hose leakage or disconnection, a stuck check valve, or a mechanically blocked pump.

### SUMMARY

In at least some implementations, a method for monitoring a fluid injection system that has a fluid pump activated by a coil and a controller adapted to drive the coil with a driving voltage includes monitoring the evolution of current flowing through the coil and the evolution of the time derivative of said current, and monitoring two successive zero crossings of the time derivative of the current flowing through the coil. The method provides an easy and cost-efficient way to discriminate various operating states of a fluid injection system including a coil/solenoid driven pump.

A method for monitoring a fluid injection system that may include a fluid dosing pump activated by a coil and an electronic module adapted to feed the coil with a driving voltage. The method may include monitoring the evolution of current flowing through the coil and the evolution of the time derivative of said current. In at least some implementations, the method may monitoring two successive zero crossings of the time derivative of the current flowing through the coil.

In some embodiments, the method can comprise:

initializing driving of the pump, said initializing comprising starting feeding the coil with a driving voltage and initializing a time of monitoring,

monitoring a first zero crossing of the time derivative of the current flowing through the coil,

monitoring a second zero crossing of said time derivative, and

determining a normal or abnormal operating mode of the pump.

According to other embodiments, the method can comprise the following features:

determining a blocking of the pump or clogging of the system, for example, when no first zero crossing happens,

a first zero crossing is detected, and the step of monitoring a second zero crossing includes detecting a time of second zero crossing of said time derivative,

determining an abnormally high output fluid pressure, for example, when no second zero crossing happens before a predetermined time out for second zero crossing detection,

detecting a minimum value of the time derivative of the current flowing through the coil before said second zero crossing,

said minimum value is compared to a predetermined minimum value, and, if the detected minimum value is below said predetermined minimum value, a dry functioning of the pump is detected,

comparing the time of second zero crossing of said time derivative with predetermined minimum and maximum times for second zero crossing,

the time of second zero crossing is below the minimum time for second zero crossing, a leakage or a missing or failed check valve is detected,

the time of second zero crossing is comprised between the minimum and maximum times for second zero crossing, and the detected minimum value is superior to the predetermined minimum value, and the system is considered to be operating normally,

calibrating the system wherein a pump resistance at room temperature is monitored and stored, and prior to the monitoring steps, a step of initializing the pump comprising:

measuring the pump resistance,

deducing a pump temperature from the pump resistance, and,

setting detection thresholds values according to the pump temperature.

At least some implementations of a fluid injection system include a fluid tank, a fluid passage in fluid cooperation with said tank, a valve, a fluid dosing pump adapted to pump fluid from said tank into said fluid passage, a coil adapted to activate said pump when fed with a voltage, and an electronic controller or module adapted to control application of a control voltage to said pump. The electronic controller also monitors a time derivative of the current flowing through the coil.

The fluid injection system may also include one or more of these additional features:

the monitor comprises a current differentiator having an output voltage proportional to the time derivative of the current flowing through the coil, thereby enabling the monitoring of said time derivative, and

the monitor comprises a signal processing module.

### BRIEF DESCRIPTION OF THE DRAWINGS

The following detailed description of preferred embodiments and best mode will be set forth with reference to the accompanying drawings, in which:

FIG. 1 is a diagrammatic view of a fluid injection system including a coil driven pump;

FIG. 2 is a schematic view of an example electrical architecture of an electronic module of a fluid injection system;

FIGS. 3a, 3b, and 3c are curves showing piston position evolution and current profiles during pump actuation in normal operation;

FIGS. 4a and 4b are curves showing piston position evolution and current profiles during pump actuation when a check valve is missing in the system or there is a leakage after pump outlet;

FIGS. 5a and 5b are curves showing piston position evolution and current profiles during pump actuation with air pumping instead of liquid;

FIGS. 6a and 6b are curves showing piston position evolution and current profiles during pump actuation with abnormally high liquid pressure;

FIG. 7 is a curve showing current profiles during pump actuation with a clogged injection system or a mechanically blocked pump;

FIGS. 8a and 8b are curves showing comparative current profiles during pump actuation with different operating conditions; and

FIGS. 9a, 9b, 9c and 9d are flowcharts that illustrate a monitoring algorithm implemented in a method.

### DETAILED DESCRIPTION OF PREFERRED EMBODIMENTS

### Description of a Fluid Injection System

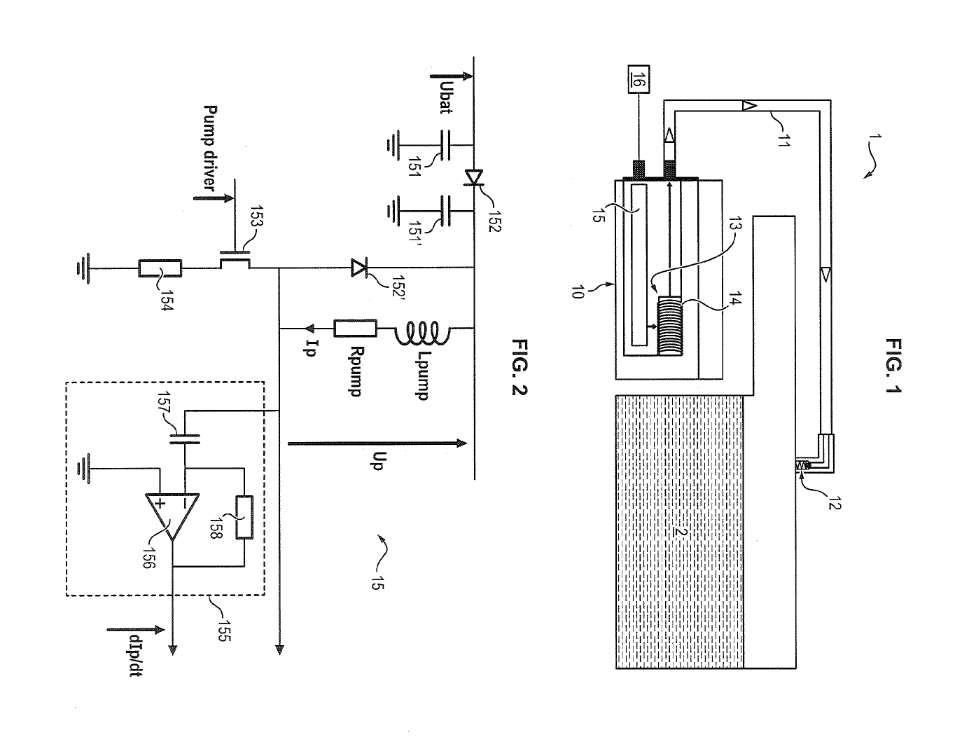

With reference to FIG. 1, or a fluid injection system 1 is shown. This system can be a fuel additive injection system, such as for diesel applications, or a fluid injection system for vehicle exhaust after treatment. The liquid may include, by way of examples without limitation, urea for SCR, diesel for diesel particulate filter regeneration, ethanol for SCR or the like. Of course, the above are just examples of implementations that may utilize a coil driven pump. The disclosure relates to any fluid injection system that includes a coil or solenoid driven pump.

This system 1 includes a fluid tank 10, such as an additive tank, a fluid passage 11 in fluid communication with the fluid tank 10 and terminated by a valve which may be an injection check valve 12. This valve 12 is in fluid communication with for instance a fuel tank 2 so that fluid that flows through the valve 12 enters the fuel tank 2. In such an implementation, the fluid tank 10 may include a dosing agent to be added to diesel fuel in the fuel tank 2. Of course, the check valve 12 may be part of a SCR system that provides a fluid, like urea, into an exhaust circuit of a vehicle. In that instance, fluid that flows through the valve 12 would enter the exhaust circuit of the vehicle.

The system 1 also includes a fluid pump 13 that may include a plunger or piston activated by a coil 14. An electronic module or controller 15 provides power (e.g. a voltage) to the coil 14, and monitors current flowing through the coil 14. This controller 15 may itself be connected to a power supply 16, such as, but not limited to, a battery of a car.

In normal operation, the controller 15 drives the pump 13 with a control voltage signal. When the voltage rises, the coil is energized and the piston is attracted in its cylinder (not shown), compressing a return spring (not shown). During this motion, fluid is ejected through an output of the pump, and then through the outlet check valve 12. Then, when voltage drops, the spring pushes the piston back to its initial position and fluid is sucked from the pump inlet.

In an opposite operative way, when the voltage rises and the piston moves in its cylinder to compress a return spring, fluid can be sucked from the pump inlet, and when voltage drops, the spring pushes the piston back to its initial position and fluid is ejected through an output of the pump.

The controller 15 is also able to monitor current profile through the coil 14 and its time derivative. This is enabled, in at least one implementation, by an electrical architecture comprising a differentiator allowing monitoring of the current time derivative through the coil.

One implementation of an electrical architecture is represented in FIG. 2. The coil is represented as an inductance Lₚᵤₘₚ and a resistance Rₚᵤₘₚ, that are fed with a voltage U_{bat} (which may be DC) from a power supply (not shown), such as the battery of a car.

First and second filtering capacitors 151 and 151′ are connected in parallel with the power supply (not shown) delivering the power voltage U_{bat}, and linked to the ground, a first diode 152 being inserted in series between the capacitors and allowing the current to flow from the power supply to the pump. This first diode protects the power supply from discharges that could come from the pump and protects the electronic controller from reverse polarization. The inductance and resistance of the pump, as well as a second diode 152′, are mounted in parallel with the output of the second capacitor 151′. The second diode is eliminating flyback (freewheel diode).

A pump driver is connected to the pump via a transistor 153. A resistor 154 links the transistor to the ground. The transistor is also connected to the input of the second diode and the output of the pump. The transistor works as a switch to drive the operation of the pump. When closed, the current from the pump flows to the resistor 154 and then to the ground. When open, the current from the pump flows back through the second diode 152′. Thus, successively closing and opening the transistor 153 corresponds to successively switching on and off the pump.

Last, a monitoring circuit 155 monitors the current time derivative dIₚ/dt flowing through the coil Lₚᵤₘₚ. Circuit 155 can include discrete electronic components or a signal processing module. In FIG. 2, the circuit 155 includes an operational amplifier 156 mounted as an inverting differentiator, i.e. having a “+” input connected to the ground, a “−” input comprising a capacitance 157, said “−” input being connected to the output of the pump, and the output of the operational amplifier being connected to the “−” input via a resistor 158. Thus the differentiator measures an input voltage proportional to the current Iₚ flowing through the coil and outputs a voltage proportional to the time derivative of said current.

### Correlation Between Current Profile Through the Coil and Piston Motion

The current profile through the coil and its derivative are directly linked to the inductance evolution of the coil driven pump during piston motion. It can be noticed thanks to the electrical equations below:

$$U = Ri + \frac{d λ}{d t}$$

With λ=Li, i.e. the magnetic flux through the coil, U being the driving voltage, R being the coil resistance, L the coil inductance and i the current flowing through the coil. The resistance R varies with a room temperature:

$$R ( T ) = T ( T 0 ) + α ( T - T 0 )$$

$$Then$$

$$U = Ri + L \frac{d i}{d t} + i \frac{d L}{d t} = Ri + L \frac{d i}{d t} + i \frac{d L}{d x} \frac{d x}{d t} + i \frac{d L}{d i} \frac{d i}{d t}$$

Where x is the instantaneous position of the moving piston.

### Then

$$\frac{d i}{d t} = \frac{U - i ( R + \frac{d L}{d x} \frac{d x}{d t} )}{L + i \frac{d L}{d i}}$$

In addition, the piston motion (position, velocity and acceleration), is characterized by the following set of equations:

$$m \frac{{d}^{2} x}{d {t}^{2}} = {F}_{m} ( x , i ) - {F}_{spring} ( x ) - {F}_{frs} - {F}_{frd} - Δ {F}_{P}$$

Where F_{frs} is static friction, F_{frd} is dynamic friction, proportional to the velocity of the piston, and ΔF_{P} are pressure effects which depend on the velocity of the piston, on the check valve, fluid passage, and other parameters of the system.

Therefore, the monitoring of the current flowing through the coil and its time derivative gives a lot of information on the behavior of the pump.

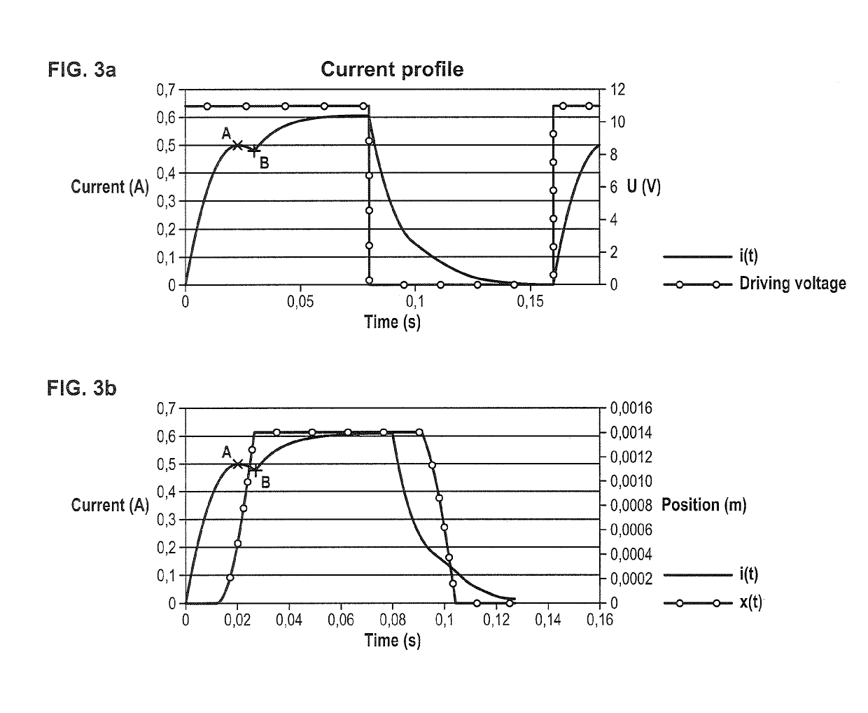

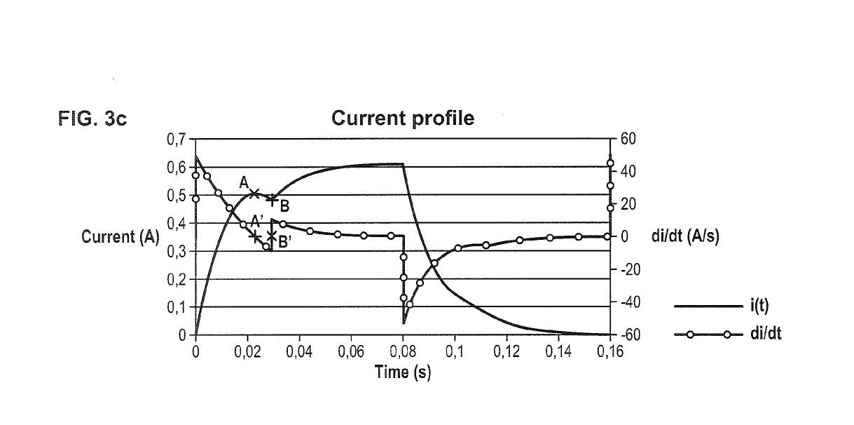

For instance, FIGS. 3a-3c show the correlation between the motion of the piston and the current flowing through the coil and its time derivative in normal operation. Normal operation comprises the pump pumping liquid and the system including an operational check valve 12. The values of the different curves are only illustrative examples; they do not limit the scope of the invention.

With reference to FIG. 3a, voltage square pulses are applied to the coil by the pump driver, the voltage values being indicated on the right-hand axis. Each pulse induces a current elevation in said coil, the current value being indicated on the left-hand axis. The current increase in the coil induces a corresponding motion of the piston inside the pump, represented in FIG. 3b, the position of the piston being indicated on the right-hand axis. The current deflection points A and B on FIGS. 3a to 3c are due to the piston motion in its cylinder, which affects the inductance value of the coil.

Indeed, as the piston starts moving inside the core, the current time derivative decreases, until first crossing 0, i.e. the current stops increasing at point A and begins decreasing. The current and corresponding time derivative reach respective minimum values, on point B and B′ when the velocity of the piston is maximum. Once the piston has reached its maximum position, the current value increases again, along with the current time derivative which crosses zero a second time, until the establishment of the current in the coil is complete.

In this nominal example, the current derivative at end of the first piston motion (at about 0.026 s) is the minimum value of the current and close to −7 A/s and the piston stroke lasts about 14 ms (roughly between 0.012 s and 0.026 s). On FIG. 3c, the current time derivative is represented, which values are indicated on the right-hand axis. The first and second zero crossing A′ and B′ are shown in this figure.

This current and current time derivative information for normal operation may be compared to the same in abnormal operation, or during operation under different conditions.

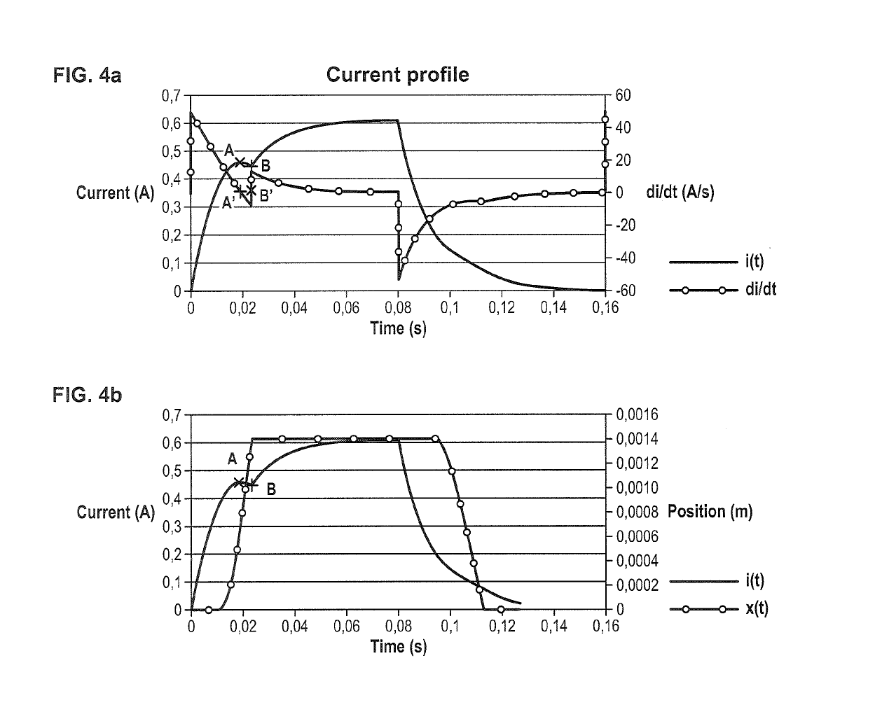

With reference to FIGS. 4a and 4b, current and current time derivative curves are shown, in an operative situation in which the pump is operated with liquid, and either the check valve 12 is missing (or stuck in an open position), or there is a leakage after the pump outlet.

It appears, particularly in FIG. 4a, that the piston motion is quicker than in normal operation (about 0.1 s), since the output pressure of the pump is lower, and therefore the current deflection points A and B induced by this motion occur sooner than in normal operation. As a consequence, the current time derivative zero crossing points A′ and B′ happen sooner than the same points in normal operation.

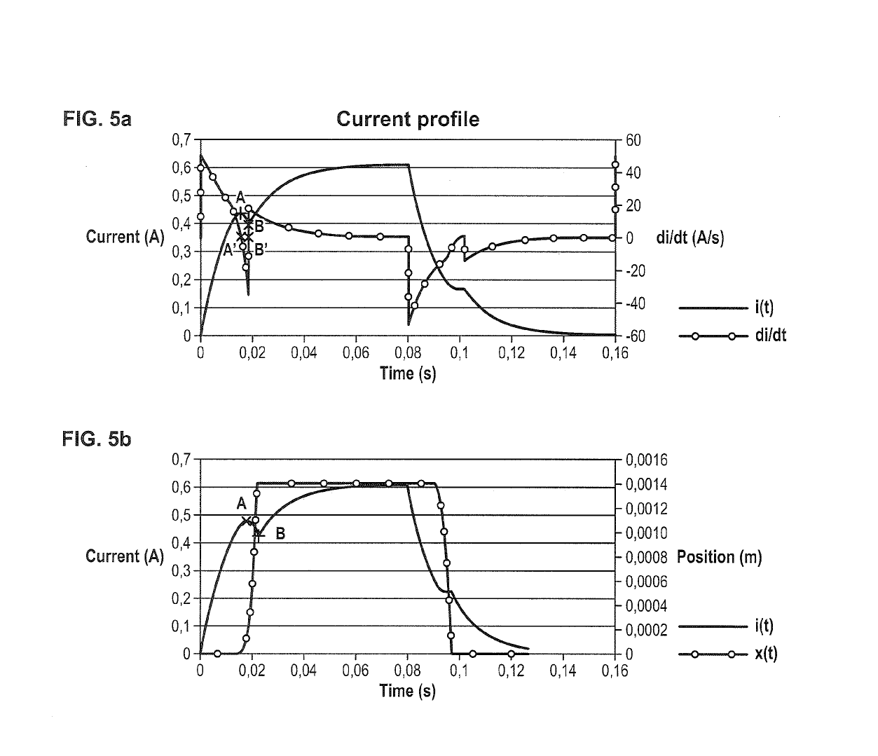

With reference to FIGS. 5a and 5b, the same curves are illustrated in an operative situation in which the pump is pumping air, for instance during system priming. This is called “dry condition”, or “dry operation”.

When functioning in dry condition, the piston motion is much quicker than with liquid (about 7 ms instead of 14 ms), and the current time derivative reaches an inferior value to that of normal operation, for instance of −32 A/s on the point B′ at end of piston motion (instead of −7 A/s). The main difference between current time derivative with air and with liquid is due to dynamic friction on the piston that is much lower with air. In addition, during motion back to the rest position caused by the return spring on the piston, the current derivative becomes positive, and then suddenly drops again. This is due to the end of motion of the piston, and a sudden zero velocity.

The operational mode of the pump can then be distinguished by evaluating the current time derivative during an “On” phase of the power supply, i.e. when a control voltage is applied to the coil. In addition, for confirmation purpose, the “jump” in current time derivative during an “off” phase (when the piston gets back to rest position) can be evaluated.

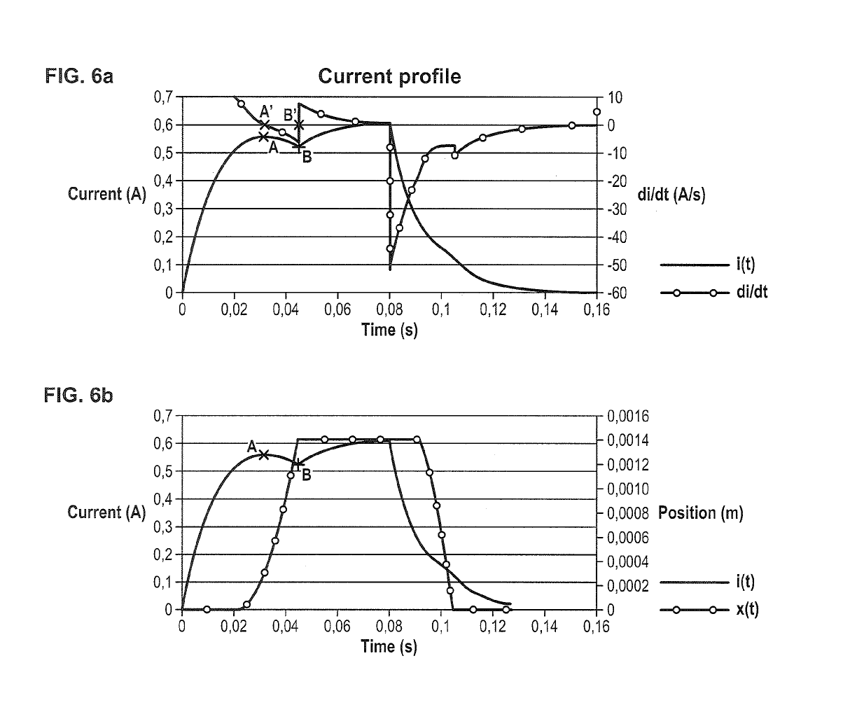

With reference to FIGS. 6a and 6b, the same curves are illustrated in an operative mode in which the pump is pumping liquid, but there is an abnormally high pressure output fluid pressure, for instance in the check valve pressure. In this situation, the start of piston motion is obtained at a higher current than with nominal check valve operation. The current time derivative during piston motion stays negative, i.e. the time elapsed between points A′ and B′ lasts 15 ms instead of 5 ms in the normal condition.

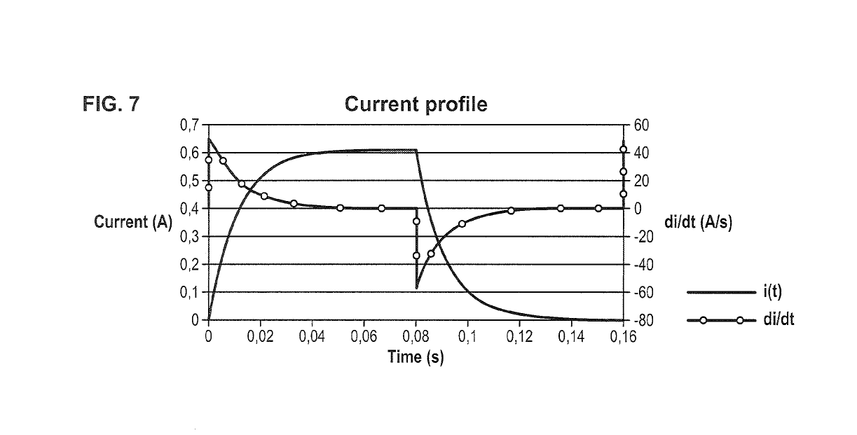

With reference to FIG. 7, curves of current and current time derivative are illustrated in an operative mode in which the system is clogged (at the pump outlet, or at the check valve for instance). In that case, the current deflection points A and B do not appear since the piston does not achieve its complete motion through the cylinder and thus do not alter the coil impedance.

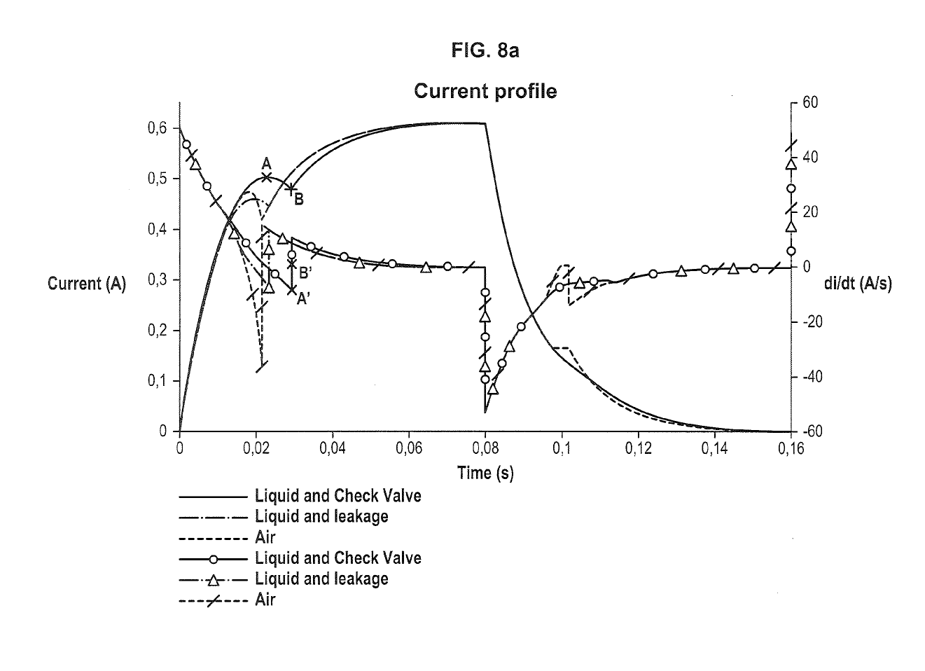

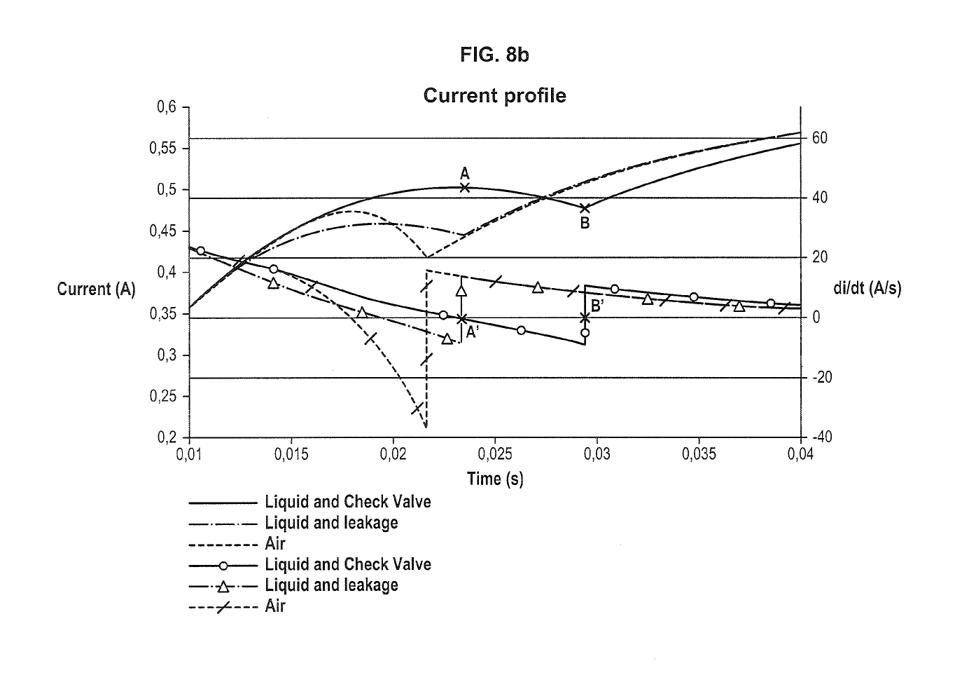

Summary current profiles are illustrated in FIG. 8a, with a focus in FIG. 8b on the zone of current deflection points (zone centered on A, A′ and B, B′). For the sake of clarity, the deflection points A, B, A′, B′ are only represented for the curve of normal operation. In these figures, the three first curves show the current profile, and the three last curves, with symbols, are current time derivative profiles.

In case there is a leakage in the system, said leakage can be easily determined by monitoring the time at which the second zero crossing of the current time derivative happens. Also, a dry operation can be detected if the minimum value of the current time derivative is below a predetermined threshold, as this minimum value is much beneath the minimum value of this derivative in normal conditions.

### Preferred Embodiment of Implementation of the Method

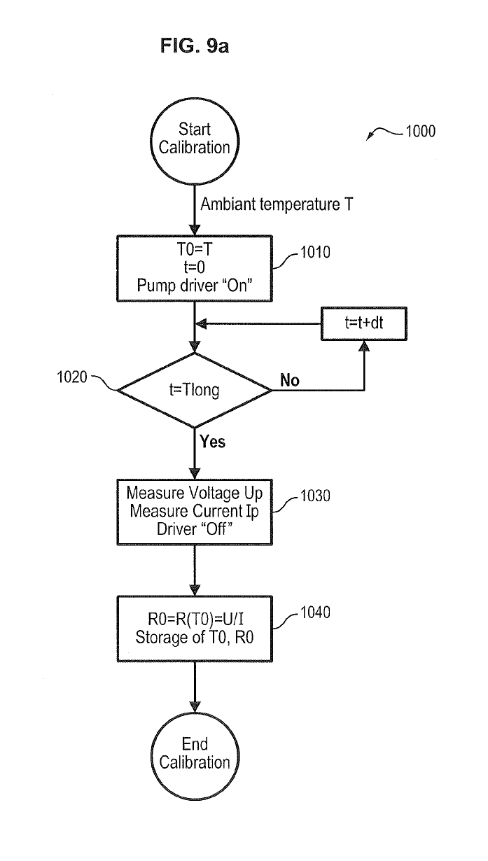

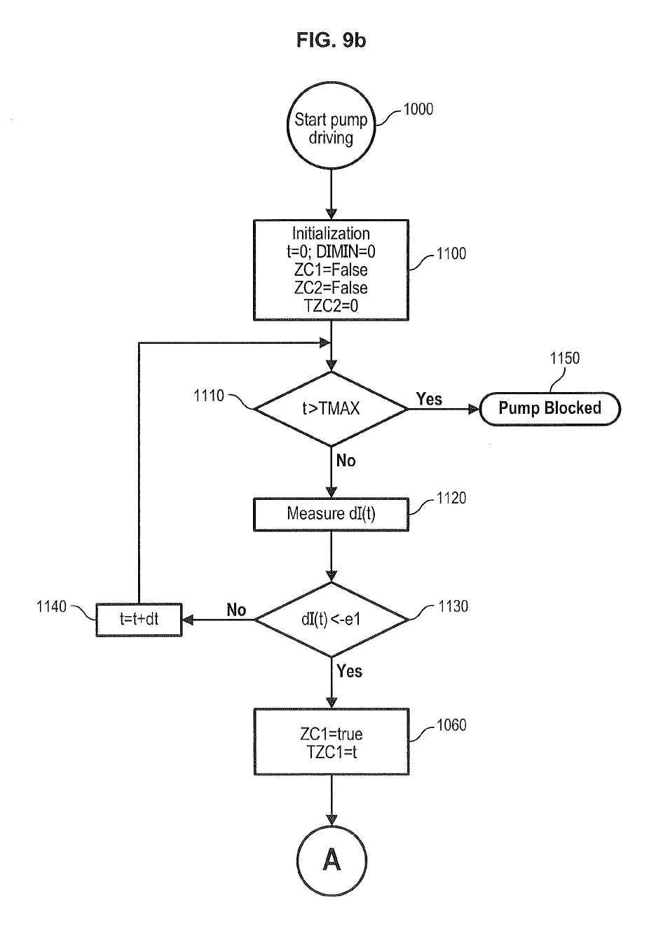

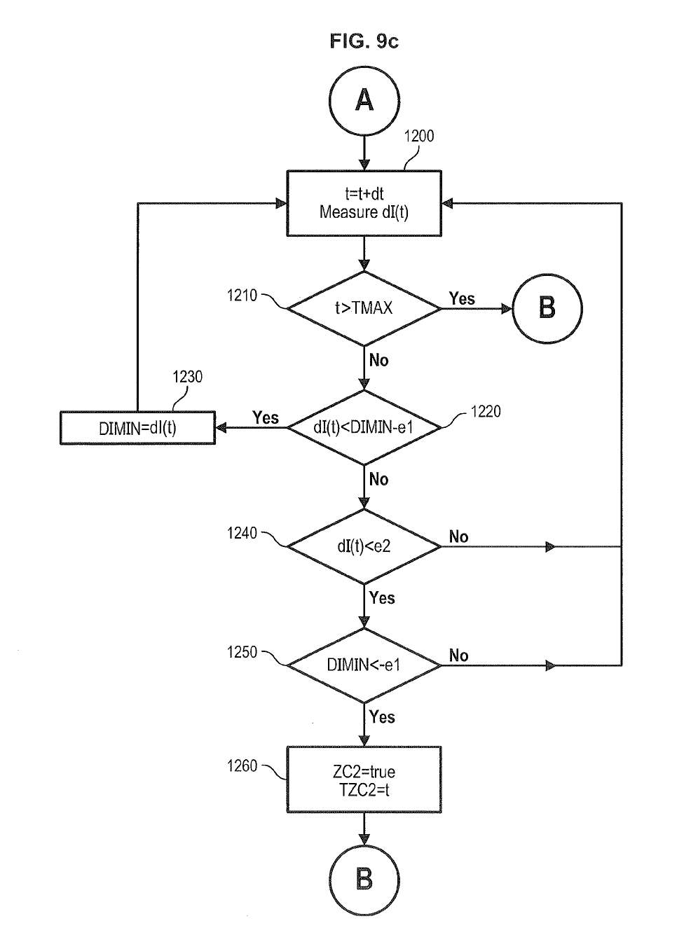

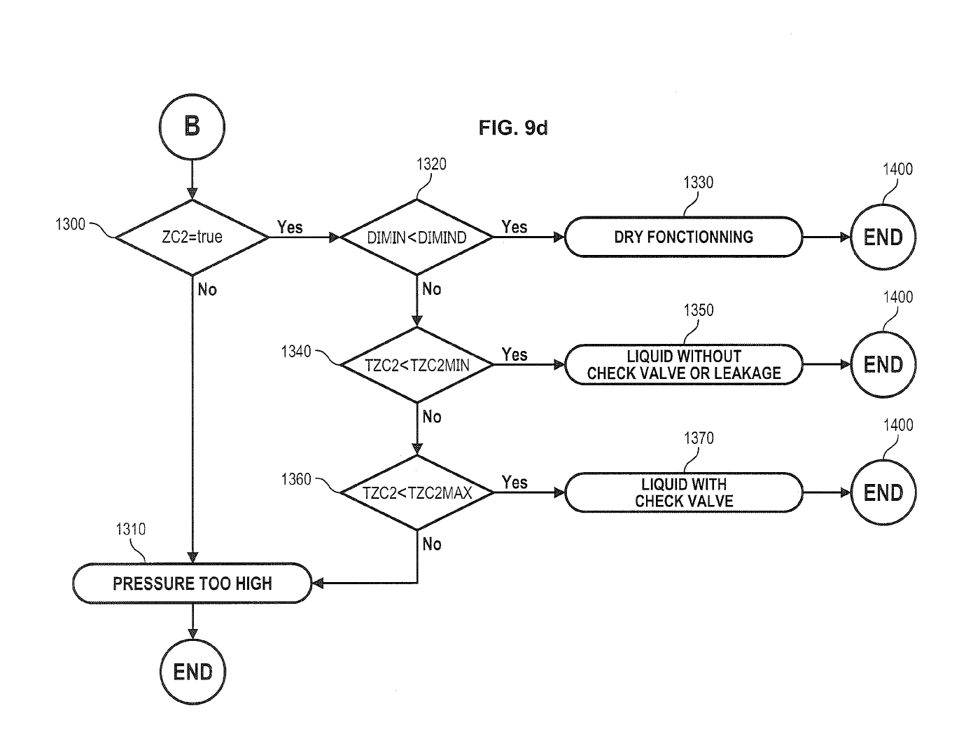

During assembly of the fluid injection system, a first step of calibration of the system 1000 is carried out, with reference to FIG. 9a. During this calibration, a room temperature is measured by the electronic controller or transmitted by external means. Afterwards, the electronic controller drives the power supply to deliver one long voltage U_{bat} pulse and measures the current flowing through the coil in steady state. More precisely, this step of calibration comprises a step 1010 of setting a recorded temperature T0 at t=0 as equal to the ambient temperature T, initializing a timer t equal to 0 s, and switching on the pump driver.

Then, a step 1020 consists in checking that the elapsed time t equals the predetermined duration T_{long} of the power signal for calibration, and if not so, waiting until t reaches T_{long}. Then, a step 1030 consists in measuring the pump voltage Up and the pump current Ip, and switching off the pump driver. Then, a step 1040 consists in setting the value of the pump resistance R0 as the resistance at the temperature T0, being equal to Up/Ip, and storing T0 and R0 in a memory of the electronic circuit (not shown).

Afterwards, and before each step of driving the dosing pump for injection of fluid, an initialization step is carried out, during which the electronic controller drives the pump over one long pulse the same way as during calibration process. The aim is to estimate pump resistance due to temperature change. More precisely, the resistance of the pump is given by the equation R(T)=R(T0)+α(T−T0). Measuring the resistance of the pump R(T), given the resistance R(T0) allows measuring the current temperature (T) in the pump, with a better precision than if the temperature was measured directly by the electronic controller.

Then, given the current temperature T, the electronic module chooses values of detection thresholds described hereinafter (TZC2MIN, TZC2MAX, DIMIND), these thresholds being sensitive to temperature changes, in an embedded look-up table or other source of such data comprising different values of these thresholds in function of the temperature.

After the initialization process, the monitoring and flow diagnostic method may include:

Detection of a first current time derivative zero crossing, indicating start of piston motion,

Evaluating a minimum value of current time derivative, in order to discriminate a dry or liquid operative mode,

Detecting a second zero-crossing of current derivative, in order to detect the end of piston motion, and

Evaluating the instant of the second zero-crossing, to discriminate between the presence of a check valve and a leakage or an absence of said check valve.

One implementation of this method is detailed with reference to FIGS. 9b to 9d. In FIG. 9b, step 1000 consists in starting the pump driver. Step 1100 consists in starting the monitoring of the pump, by:

initializing a time recording t=0,

setting a minimum value of the current time derivative DIMIN to 0 A/s,

setting two flags ZC1 and ZC2, indicating respectively first and second zero crossing of current time derivative, as “false”, meaning said derivative has not crossed zero yet, and

setting a time TZC2 of second zero crossing of time derivative to 0 s.

A predetermined time TMAX is set, corresponding to the time out for zero crossing of the current time derivative. This time may be determined by recording several times of first and second zero crossing detection in normal operation. A step 1110 consists in checking if the elapsed time t exceeds this time TMAX.

If not, the current time derivative dI(t) is measured at time t during step 1120, and it is compared during step 1130 to a threshold −e1 (e1 being a positive value), corresponding to a safety margin to accommodate noise disturbance. If dI(t)<−e1, the derivative is considered to be negative.

If dI(t) is not less than −e1, then the recording time t is incremented at step 1140 and steps 1110 to 1130 are iterated until the current time derivative is negative, unless the time t exceeds time TMAX at which the derivative is supposed to have crossed zero. In that case, the pump is determined to be blocked at step 1150, and the process terminates.

Conversely, if before the time TMAX, the current time derivative reaches a value below −e1, then it is considered that the derivative has first crossed zero. Thus, at step 1160, the time t at which said value −e1 is reached is registered as the time TZC1 of the first zero crossing of the current time derivative. The flag ZC1 of first crossing of zero is set equal to “true”. Then, with reference to FIG. 9c, a step 1200 of incrementing time t and measuring the current time derivative at this time t is implemented.

If t has not exceeded TMAX (comparison step 1210), then, during step 1220 the current time derivative dI(t) is compared to DIMIN−e1. As DIMIN has initially been set to 0, this comparison is the same as step 1150, and the result is positive. DIMIN is then set to the value of dI(t) at step 1230, and steps 1200 to 1220 are iterated until dI(t) is not less than DIMIN−e1 anymore. Thus, these iterations aim at detecting the minimum value reached by the current time derivative after its first zero crossing.

At step 1220, after the various iterations, dI(t) not being less than DIMIN−e1 means that the current time derivative has stopped decreasing. At step 1240, dI(t) is compared to a second positive threshold value e2, in order to detect that the current time derivative has increased until being positive again. If not, steps 1200 to 1220 are iterated until dI(t) exceeds e2.

When dI(t) exceeds e2, the stored minimum value DIMIN of the current time derivative is compared at step 1250 with −e1, in order to determine for sure that, when dI(t) reached DIMIN, it was negative. In that case, the transition from DIMIN to a value exceeding e2 indicates that the current time derivative has crossed zero a second time.

Then, at step 1260, the flag ZC2 indicating that a second zero crossing has occurred is set equal to “true”, and the time at which all steps 1200 to 1250 have been overcome is registered as the time TZC2 at which the second zero crossing happened. The process then continues on step 1300 in FIG. 9d.

However, if after the various increments of the monitoring time t, the latter becomes greater than TMAX (step 1210), the process directly continues on step 1300 in FIG. 9d. Step 1300 consists in checking the flag ZC2.

If ZC2 is false, which is the case it this step is carried out immediately after step 1210 of checking the monitoring time t, it means that after the first zero crossing of the current time derivative, no second zero crossing has been detected before a time equal to TMAX has elapsed.

TMAX is preferably defined as a time greater than the normal time of happening of the zero crossings, like for instance TMAX=0.04 s on FIG. 6a, for detection of a high fluid output pressure. t being superior to TMAX happens when there is an abnormally high output pressure of the fluid, for instance in the check valve. Thus, if t>TMAX, an abnormally high output pressure of the fluid is detected on step 1310 and the process is terminated on step 1400.

Conversely, if t<TMAX (like after step 1260); a step 1320 occurs of comparing the minimum value of the current time derivative DIMIN before the second zero crossing, and stored at step 1230, to a predetermined minimum value of the current time derivative DIMIND, said value being a threshold on DIMIN for detection of dry functioning of the pump, as represented in FIG. 5a.

Thus, if DIMIN is inferior to DIMIND, a dry functioning of the pump is detected at step 1330, and the process then terminates on step 1400.

Conversely, if DIMIN is superior to DIMIND, the process continues to step 1340. In this step, the time TZC2 at which the current time derivative crosses zero a second time is compared to a predetermined minimum time TZC2MIN at which this second zero crossing should have happened. This minimum time is set at a value allowing the detection of a leakage or an absence of a check valve in the system. Indeed, with reference to FIG. 4a, in that case the second zero crossing happens earlier than in normal operation.

Thus, if TZC2 is inferior to TZC2MIN, a leakage or the absence of a check valve is detected on step 1350, and the process terminates at step 1400. Conversely, if TZC2 is found superior to TZC2MIN, the process continues on step 1360. This step consists in comparing the value TZC2 to a predetermined maximum time TZC2MAX at which the second zero crossing of the current time derivative should have happened.

With reference again to FIG. 6a, depending on the values of TMAX and TZC2MAX, a monitoring time t inferior to TMAX but greater than TZC2MAX can also be indicative of an operative mode in which the liquid output pressure is too high. Thus, if TZC2 is superior to TZC2MAX, an abnormally high fluid output pressure is detected in step 1310, and the process terminates at step 1400. Conversely, if TZC2 is less than TZC2MAX, then no flaw has been detected, the system is considered to run in normal operative mode at step 1370, and the process terminates at step 1400.

TZC2MIN, TZC2MAX, and DIMIND may be included in the electronic module/controller as temperature-dependent look up tables, hence the measure of temperature in the calibration step.

The method disclosed provides an easy and cost-efficient way to discriminate various operating states of a fluid injection system including a coil/solenoid driven pump, comprising a normal operating mode, a dry mode, a clogged system, an abnormally high pressure in the system, or a functioning mode without check valve or with a leakage after the pump.

While the forms of the invention herein disclosed constitute presently preferred embodiments, many others are possible. It is not intended herein to mention all the possible equivalent forms or ramifications of the invention. It is understood that the terms used herein are merely descriptive, rather than limiting, and that various changes may be made without departing from the spirit or scope of the invention.

1. A method for monitoring a fluid injection system that has a fluid pump activated by a coil and a controller adapted to drive the coil with a driving voltage, the method comprising:
monitoring the evolution of current flowing through the coil and the evolution of the time derivative of said current, and monitoring two successive zero crossings of the time derivative of the current flowing through the coil.

2. A method according to claim 1, also comprising:
starting driving of the pump, said starting comprising beginning feeding the coil with a driving voltage and initializing a time of monitoring;
monitoring a first zero crossing of the time derivative of the current flowing through the coil;
monitoring a second zero crossing of said time derivative; and
determining a normal or abnormal operating mode of said pump.

3. A method according to claim 2, wherein a blocking of the pump or clogging of the system is detected when no first zero crossing happens.

4. A method according to claim 2, wherein a first zero crossing is detected, and the step of monitoring a second zero crossing comprises detecting a time of second zero crossing of said time derivative.

5. A method according to claim 4, wherein no second zero crossing happens before a predetermined maximum time out for second zero crossing detection, and an abnormally high output fluid pressure is detected.

6. A method according to claim 4, further comprising monitoring the time derivative of the current flowing through the coil reaching a minimum value before said second zero crossing.

7. A method according to claim 6, wherein said minimum value is compared to a predetermined minimum value, and, if the detected minimum value is below said predetermined minimum value, a dry functioning of the pump is detected.

8. A method according to any of claim 4, comprising comparing the time of second zero crossing of said time derivative with predetermined minimum and maximum times for second zero crossing.

9. A method according to claim 8, wherein, if the time of second zero crossing is below the minimum time for second zero crossing, a leakage or a missing check valve is detected.

10. A method according to claim 8, wherein the time of second zero crossing is comprised between the minimum and maximum times for second zero crossing, and the detected minimum value is greater than the predetermined minimum value, and the system is considered to be operating normally.

11. A method according to claim 1, further comprising:
a step of calibration of the system wherein a pump resistance at room temperature is monitored and stored; and
prior to the monitoring steps, a step of initializing the pump, said step comprising:
measuring the pump resistance;
deducing a pump temperature from the pump resistance; and
setting detection thresholds values according to the pump temperature.

12. A fluid injection system, comprising:
a fluid tank;
a fluid passage in fluid cooperation with said tank;
a valve in communication with the fluid passage to control the flow of fluid discharged from the fluid passage;
a fluid dosing pump adapted to pump fluid from said tank into said fluid passage;
a coil adapted to activate said pump when fed with a voltage; and
an electronic module adapted to feed said pump with a control voltage and having a time derivative monitor of the current flowing through the coil.

13. A fluid injection system according to claim 12, wherein the time derivative monitor comprises a current differentiator having an output voltage proportional to the time derivative of the current flowing through the coil, thereby enabling the monitoring of said time derivative.

14. A fluid injection system according to claim 12, wherein the time derivative monitor comprises a signal processing module.
